(19) United States
(12) Patent Application Publication
(10) Pub. No.: US 2006/0294499 A1
(43) Pub. Date: Dec. 28, 2006

(54) A METHOD OF EVENT DRIVEN COMPUTATION USING DATA COHERENCY OF GRAPH

(76) Inventor: John Shim, Paramus, NJ (US)

Correspondence Address: JOHN SHIM, 634 SAYRE LANE, PARAMUS, NJ, 07652, US

(21) Appl. No.: 11/160,459

(22) Filed: Jun. 24, 2005

(51) Int. Cl. G06F 9/44

(52) U.S. Cl. 717/107

(57) ABSTRACT

Continuous streams of multiple concurrent events are handled by a system using computation dependency graph. The computation dependency graph is derived from the mathematical concept of directed graph. The computation dependency graph has plurality of nodes representing typed or non-typed variables and arcs connecting from tail node to head node representing dependency of computation. The instance of a graph has plurality of node instances, and any node instance may be associated to external stream of event where a single event from the event stream changes the value of the node instance. The computation of a node is preformed when one or more of its tail node instance values are changed. The end result of the computation from tail to head makes the nodes connected by arcs to be coherent. The computation dependency graph has plurality of instance of the graph whose topology representing computation path may be reconfigured during the traversal of the node instances. A grammar to produce easy to read description of the computation dependency graph is understood by the system. The system produces data structure and instruction sets for the node computation according to descriptions conforming to the grammar by parsing the descriptions. The system has a computation engine to correctly traverse the graph instances described by the graph descriptions to processes events in most optimal manner. This invention includes various techniques and tools which can be used in combination or independently.

### COPYRIGHT NOTIFICATION

A portion of the disclosure of this patent document contains material which is subject to copyright protection. The copy owner reserves all copyright rights whatsoever.

### BACKGROUND OF THE INVENTION

Real-time event driven programming (EDP) processes data as it occurs. Real-time process requires prompt result of the event processing. Usually there are many different types of events in EDP. The events are changes in values associated with particular source. For example, a keyboard event is a change in the state of a pressed key, a mouse event is a change in mouse position or the state of mouse button. In these cases, sources of events are mouse and keyboard. Some events are not necessary associated with hardware devices. There are events whose sources are organized in special ways. In a financial market, a stock price change can be viewed as an event. As the trading price or other transaction information is updated from the exchange, the changes are fed into a network where one or more program receives and process that change as events on stock ABC occurs. In this case, the changes by the transaction of stock ABC is considered to be events on stock ABC.

Usually, processing of the events are so called hard-coded into a program written in conventional programming languages like C, C++, Java, Basic, and etc, and very expensive to maintain. Those mentioned conventional programming languages lack the native features that can handle the concept of events driven processing, it is usually a third party programmer's responsibility to implement the intricate interaction and processing of the events. This usually requires highly skilled programmers and or complex set of programming libraries which has steep learning curve.

In a conventional programming approach, multiple event sources are handled in conceptually sequential manner. When a conventional event processing program starts from a single entry point called “main”, the main thread may spawn separate thread to handle events called event thread or may use itself as the event thread. The event thread will process a queue of events. The queue will be served first come first served based. The event thread traverses precompiled map of actions associated with the events. Usually this type of implementation tends to “glue” the chain of actions and events into the programming implementation such as event handling methods. This is one of the reasons why it is very expensive to change the actions and events in the system.

As the events and the chain of actions of events gets complex beyond certain point, the objective of event handling interaction becomes very difficult with conventional programming approaches like some form of directed graph implementation, state machines, or case based event handling. Firstly, the task of modifying and putting additional event is daunting even for the skilled programmer because the programmer first need to understand how the new events will be interacting with rest of the event nodes and data node, and extract the prior relationships and concepts among different events decoded by the conventional programming language which may be spread out and buried deeply under the other implementation codes.

Due to the clear distinction between expert knowledge of the field to be applied in handling event and the knowledge of implementing the objectives in computer system, it is beneficial to those who have the expert knowledge of the event handling to be able to express its knowledge and objectives in a abstract manner. The expert knowledge is the ability to identify the relationship among the logical elements of the subject of interest in this case. A tool that can aid the expert in the field objective to express freely without knowledge of the systems programming is tremendously beneficial in developing complex idea on event handling using computation dependency graph (“computation graph”) of the present invention.

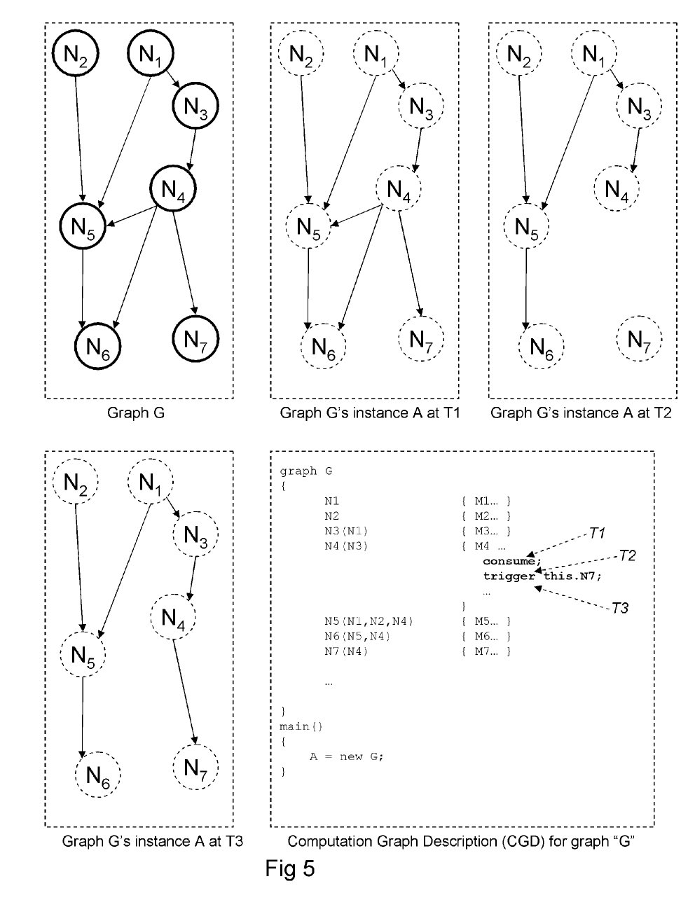

The computation dependency graph of the present invention is derived from the mathematical concept of directed graph in graph theory. A directed graph (or digraph) consists of non-empty finite set N(G) of elements called Node(vertices) and a finite set A(G) of ordered pairs of distinct nodes called arcs. For convenience, we call N(G) the node set, an A(G) the arc set of G. We'll also write G=(N,A) which means that N and A are the node set and arc set of G. The order of G is the number of nodes in G, will be denoted by |N(G)|, number of arcs in G by |A(G)|. For an arc(u,v) the first node u is its tail and the second node v is its head. A pair of distinct nodes in G{n1, n2} is reachable if there is a set of arcs starting from n1 to n2 regardless of the distance of the two nodes. If there is a node n in G where (n, n) is reachable by series of arcs A whose |A| is greater than one, the G is said to have a loop. A path of graph can also be denoted by P(n₁, n₂, . . . nₑ), where the path is set of arcs from (nᵢ, nᵢ₊₁) for each i where 0<i<e. There are numerous studies in the method of traversing node connected by arcs in the mathematical arena. The present invention relates generally to the application for handling concurrent event processing using computation graph. Knowledge in graph theory, systems programming, and parallel distributed processing will be helpful to see the advantages and features of the present invention even though all necessary description can be found in here. In computation dependency graph, the tail node is the triggering node, and the head node is the dependent node. Refer FIG. 5 for a sample computation graph.

### SUMMARY OF INVENTION

The objective of the present invention includes; providing method of designing complex event driven computation especially but not limited to financial data processing using computation graph (“graph”); providing method of utilizing human readable graph using Computation Graph Description (“CGD”); providing method of adding and removing relationships for already existing graph; providing a method of arranging the subcomponents of a graph to automatically prevent the formation of loop in the graph; providing a method of optimally visiting all paths logically related events; providing method of dynamically modifying the topology of the graph on-the-fly during the computation cycle of the said graph; providing method of writing and receiving the CGD and create machine executable data structure of the graph and its instances; provides the method of binding the graph with actual event from event receiving devices such as network interface card, serial and parallel interfaces, and other signal receiving devices attachable to the system, so that interpreted information can be presented to user through output devices such as disk, character and graphics display, and sound interfaces. With the above stated objective, the present invention provides an environment where an expert's knowledge of events can be expressed easily and applied without significant understanding of the systems programming.

A computation dependency graph has a few important properties. The first property of the computation graph is that the computation graph G has no loop. The second property is that each node has a value, and there are dependency relationships of among the node values. The third important property is that there is a computer executable instructions associated with each node, where the instruction is executed to satisfy dependency relationship. The fourth important property is that a node in a computation graph has traversal order, where all dependency relationship is satisfied at once by executing the instructions of the node according to the node orders.

In accordance with an exemplary embodiment, a method consistent with the present invention of Computation Dependency Graph System (CDGS) include: receiving graph description defining the flow of actions to be taken for each event; providing graph instance initialization as well as graph initialization method; providing dynamic modification of computation topology; synchronizing graph to event by computing all nodes who are reachable from the nodes associated with events.

Another method of CDGS consistent with an embodiment of the present invention include: providing a method of representing graph using nodes, arcs, and machine executable CGD program segment (“method”) for nodes and CGD method for the graphs; translator for the CGD code to create graph template data structure; elaborating the data structure into instances corresponding to the graph described by the CGD; method of biding events with node instances of a graph; provide the graph execution engine to obtain computation of data for the events.

A method of describing a graph in a graph description method include; providing the name of graph, defining a node which contains one or more value of specified type; describing method which will be executed upon the node being fired; defining arcs representing the triggering path; a method of arranging those component in human readable format which will prevent a loop in the graph thus removing infinite computation loop upon an event being fired.

A computer system for processing graph description consistent with embodiments of the present invention includes one or more processors. And input circuit coupled to the processor receives graph description. A storage arrangement is coupled to the processor for storing computer programs and data. A program receives the graph description. A connection to receive events such as but not limited to network interface card, various real-time information receiver, keyboard, and mouse. A device to present the interpretation of the events to the user such as but not limited to character and graphics display, sound generating circuits, and other human perceivable devices.

Many variations, equivalent and permutations of these illustrative exemplary embodiments of the present invention will occur to those skilled in the art upon consideration of the description of this document. The particular examples shown here should not be considered to define the scope of the present invention; provide a method of achieving processing of real-time financial market data without requiring tedious, error-prone difficult-to-understand formal-programming and operating-system protocol

### DETAILED DESCRIPTION

In the following description, numerous specific details are set forth to provide a thorough understanding of the present invention. However, it will be obvious to those skilled in the art that the present invention may be practiced without such specific details. In other instances, well-known circuits have been shown in block diagram form in order not to obscure the present invention in unnecessary detail. For the most part, details concerning hardware implementation, timing considerations, and the likes have been omitted inasmuch as such details are not necessary to obtain a complete understanding of the present invention and are within the skills of persons of ordinary skill in the relevant art.

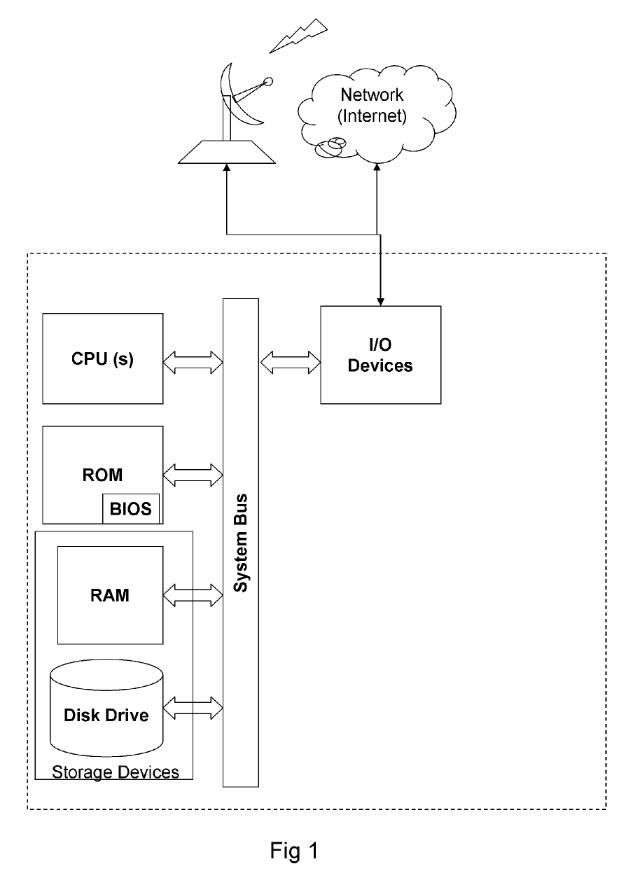

Refer now to the drawings wherein depicted elements are not necessarily shown to scale and wherein like or similar elements are designated by the same reference numeral through the several views. The present invention is applicable to any field of event driven process, but is specifically described herein with respect to financial application examples. The methods described here in with respect to the present invention may be implemented in other fields of interest besides financial applications. The methods and structure described herein with respect to the present invention may be implemented with any data processing system, such as the computer system (“computer”) described with respect to FIG. 1.

Referring first to FIG. 1, an example is shown of a computer system which may be used for the present invention. The system has a central processing unit (CPU). The CPU is coupled to various other elements by system bus circuits. Read only memory (ROM) is coupled to the system bus and includes a basic input output system (BIOS) that controls certain basic functions of the computer system. Random access memory (RAM), input output device, and communications devices are coupled to the system bus. Input Output devices may be a device to communicate with a disk storage device. Storage devices include RAM, disk drive, or any other information storage that can be retrieved to the computer system. Communication devices may be a network interface adapter that enables the computer system to communicate with other such systems. Input output devices are also connected to the system using electronic circuit, and input output devices may includes keyboard, mouse, display monitor, through satellite receiver, FM and other wireless and wired communication devices.

Preferred implementations of the present invention include implementation of a computer system described above programmed to execute the method or methods described herein as yet another computer program product. In the computer system implementation above, set of instructions for executing the method or methods may be resident in the random access memory of one or more computer systems configured generally as described above. The set of instructions may be stored as a computer program product in other types of computer storage that can hold the product without constant supply of electricity to the system such as magnetic drive, optical drive, solid state drive, compact disk medium, DVD medium, and other computer system over network as well as RAM. The change of the instructions for storage may be electrical, magnetic, chemical or some other physical changes. The stored computer program products may be loaded into user's computer system at any time to be executed. While it is convenient to describe the present invention in terms of instructions, symbols, characters, or the likes, all of these and similar terms should be associated with the appropriate physical elements.

The present invention will be further clarified by consideration of the following example of a preferred embodiment, which is intended to be exemplary of the present invention. In a preferred embodiment, the present invention provides an apparatus and method as a concurrent event handling application. A preferred embodiment of the present invention receives Computation Graph Description (“CGD”) stored in computer storage either created by user or by user interface tools, a parser receiving CGD code, an Computation Graph Runtime Module to elaborate a plurality of instance of the computation graph described by the CGD code, and to process external events associated with graph instances.

The present invention derives a computation dependency graph (“computation graph”) from mathematical concept of directed graph. The computation graph in the present invention has a plurality of ordered nodes and arcs, where each node has a state, a value, a method, and plurality of arcs. There are three state of a node which are synched, dirty, and consumed. The state of a node describes the state of the value of the node. A method of a node (“node method”) is a set of machine executable instructions or higher level language representation of the executable instructions. An arc in the computation graph represents conditional dependency relationship of distinctive two nodes in the graph. The conditional dependency relationship is coherent if the states of all nodes are not dirty. The coherency of dependency relationship in the computation graph breaks when a triggering node value is updated and different from the previous. The computation graph is coherent when all dependency relationships in the graph are coherent. A set of computation graphs instances with same node dependent relationship and node methods can be classified to a class of graph instances. Since the behavior of among the instances of a class of computation graph are same, class of computation graph and instance of computation graph is used synonymously through out this document to explain their behaviors and characteristics unless otherwise specified. In the present invention a class of computation graph can be described using Computation Graph Description.

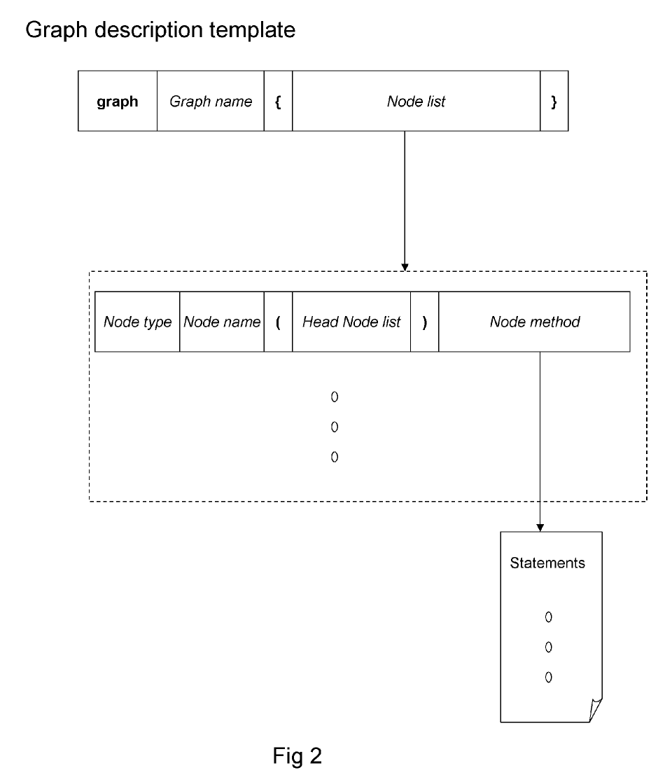

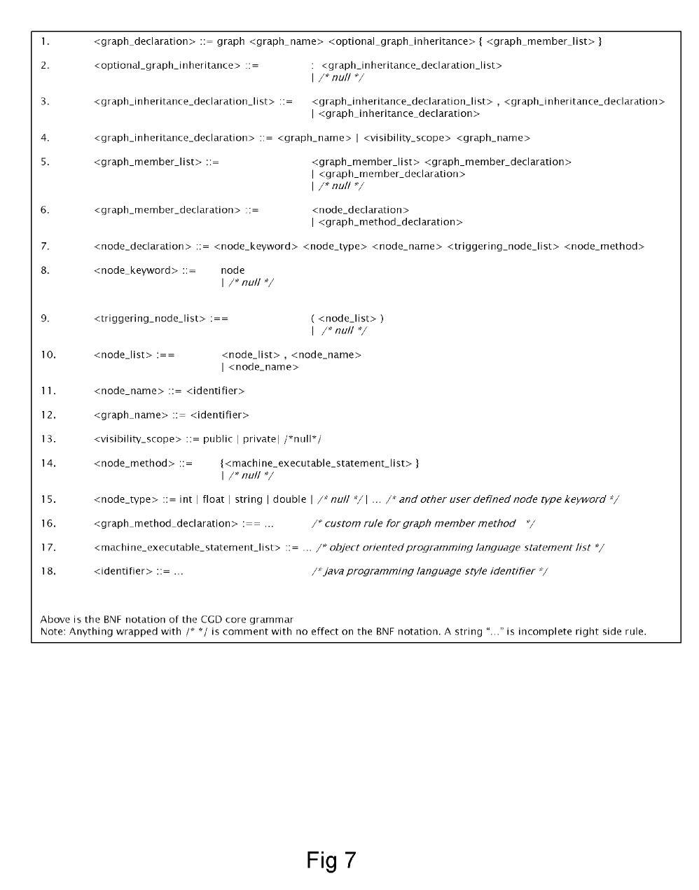

Referring to FIG. 2, the present invention provides a method of writing a class of computation dependency graph to computer storage in the form of CGD code compliant with CGD grammar. Some parts of the grammar are not described in detail because it is not necessary to obtain a complete understanding of the present invention. The method of transforming computation graph to CGD code is carried out by a computer program such as text editor or a special graphical user interface. The use of such program is obvious to those who are skill in the art. A computation graph is written according to following method; where special characters and keywords can be substituted according to the culture; CGD starts with keyword “graph”²⁰¹; followed by the name of the graph²⁰¹; followed by optional graph inheritance (refer FIG. 7, rule 2.); and continues to node list block which starts with a special character ‘{’²⁰³; continue to write node list²⁰⁴ by writing zero or more node declaration²⁰⁵ separated by special character ‘;’ or node method; write node declaration starting with the optional keyword “node”²⁰⁶ followed by the optional variable type²⁰⁷ which can also be omitted to assume the node is associated with variant data; continue to write node declaration by writing the name of the node²⁰⁸; continue to write node declaration with triggering node list²⁰⁹, however if there is no triggering node then the list may be omitted; write triggering node list by starting with a special character ‘(’²¹⁰; continue to write triggering node list²¹¹ by writing the name of dependent nodes separated by special character ‘,’ and white space. Node names in the triggering node list must been declared previously within the same graph description. This rule will force the writers to remove loop in graph described by the CGD. A triggering node list is closed by writing a special character ‘)’²¹² if a triggering node list is started in the current node declaration; continue to write node declaration with optional node method declaration starting with special character ‘{’²¹⁴; continue to write node method with node method statement list which uses conventional object oriented programming language such as C++, java, or its variations; continue to write node method using special keyword “consume” in order to suspend the dependent node update from the current node and keyword “trigger” with optional node name to trigger the computation of dependent nodes; close node method with special character ‘}’²¹⁶; continue to write list of graph-wide method using object method in using modified conventional object oriented programming language such as C++, java; close graph with special character ‘}’²¹⁷.

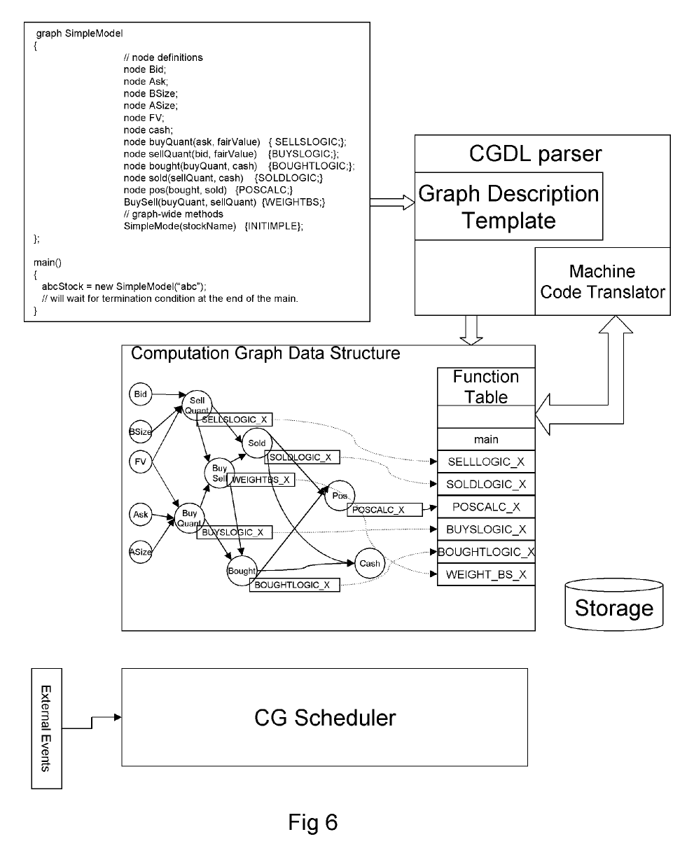

Referring to FIG. 7, A BNF notation of the CGD core grammar is presented to elaborate the CGD core grammar. The BNF is an acronym for Backus Naur Form. The custom rules with empty right hand side are left out empty because particular implementation of the rule is not forced in this invention, and may be completed using slightly modified version of third party conventional object oriented programming language like C++ or Java. Implementing third party grammar variants, preferably C++ or Java variants for the present invention is within the skills of persons of ordinary skill in the relevant art. The method of addressing the graph instance from a non static member function of the graph instance is similar to the way C++ or Java uses “this” keyword. As an example, if a node name “symbol” in a graph “SimpleModel” is addressed in a method of the SimpleModel, it will be expressed as “this.symbol”⁶⁰⁶(refer FIG. 6).

A preferred embodiment of the present invention includes a parser to read CGD code from computer storage like disk or memory to create data structure to represent classes of computation graph. The process of parsing CGD is carried out by the CGD parser (“parser”). The parser in the present invention scans tokens in the received CGD code. The tokens are recognized by the parser. Tokens are categorized by symbols, keywords, operators, constants, and identifiers, and white spaces according to CGD lexical rules. In this invention, the keywords and symbols of the CGD can be substituted with other parser recognizable tokens. It will be appreciated by those skilled in the art having the benefit of this disclosure that the CGD parser can be implemented with various parsing methods including top-down, and bottom-up, and with and without various parser generating tools. The implementation details of the parser will be obvious to those who are skill in the art.

The CGD parser in the present invention, starts to recognize graph definition by reading keyword “graph” from a CGD code, then it expects to see name of the graph, and optional graph inheritance as described in the BNF notation in the FIG. 7 rule 2, then the symbol ‘{’. The CGD parser in the present invention then expects to see list of node declarations. During the parsing of node declarations in the CGD code, each node is assigned with a node order according to its order of lexical appearance in the CGD code. As an example, a CGD code for a graph G⁵⁵⁰ in FIG. 5 will be translated by the parser to a data structure representing a class of computation graph whose nodes are ordered as; N1, N2, N3, N4, N5, N6, N7. A node declaration starts with an optional keyword “node”, and followed by another optional type name. The type name is user agreed keyword representing the type of the value, which may have implicit meaning of its data size in computer system and how it is interpreted through the method. When the type name is not presented in the node declaration, the type is assumed to be a variant type. The variant type can be anything with specific data size including boolean, string, integer, time, and real number. The node declaration is continued with an identifier representing the node name, then the triggering node list. The triggering node list is expected to start with symbol ‘(’ and list of node names separated by a symbol ‘,’ and finally expected to end with symbol ‘)’. All nodes in the triggering nodes list must have been defined previously within the same graph_declaraction or it's parent's graph_declarations. The parser looks up the previously defined nodes in the current graph definition block from the data structure of the current graph. If a node in the triggering node list was not recognized earlier, the parser reports it to user as an error, and invalidate the current graph. The method of rejecting an unknown node in the triggering node list ensures that the node parsed successfully will have no loop in dependency relationship. The layout of CGD code that is expected from the parser of the present invention guides users to write highly readable graph dependencies. It makes the management of the node dependency clearer and easier. After parsing the triggering node list, the parser expects an optional node method which will be executed when the node state is changed to dirty by one or more triggering nodes or events associated with the node. The node method and the triggering node list may be empty with.

The CGD parser in the present invention read statement list in a node method to construct internal data structure, which later can be used to create instances of the graph, and can be traversed for execution or for translating to machine instructions. The node method data structure has links to the its graph, a graph containing the node of the method, allowing access to all the nodes of the its graph. The access to the graph nodes from a node method is done using access operator “this”. The use of “this” is similar to the way where C++, and java is accessing its member through “this”. The node method data structure also has links to the triggering node of the graph where the instance of the dependent node is treated as parameters to the node method, allowing immediate access to the dependent node from the node method which may be used without using indirect referencing through “this” graph instance.

The CGD parser in the present invention recognizes three different types of methods; which are graph method, node method and static method. The graph method is equivalent to C++'s class method. The static method is also equivalent to the C++'s static method. The node method are method invoked when a node is triggered and the node state is dirty.

The parser in the present invention can read native CGD grammar or can preprocess more conventional object oriented language including C++, and java to construct CGD equivalent data structure after the combination of preprocessing and the parsing. However, various modifications can be made to parse other object oriented grammar for statement because a graph can be viewed and accessed the similar way the class is accessed in conventional object oriented language like C++.

The Computation Graph Runtime Module (“CGRM”) in the present invention, receives the control from the loader, and searches the “main” function in the graph data structure created from CGD code, and execute the method which will dynamically creates the instances of the graph programmatically during the execution of the main and its subsequent method calls. During the execution of the method, a binding of event source to a node of an instance of graph can be performed by passing the reference of the node instance to event queue. When a value associated to the event is removed from the queue, the value is copied to the bounded node.

In the present invention, A node in a graph instance has three states; synched, dirty, and consumed. A node goes in synched state right after a node has been initialized. Whenever the node value is changed, the node goes into dirty state, and the node becomes dirty node. The node also has path consumed state. The path consumed state is set by a executing an instruction corresponding to “consume” keyword. When the CGRM encounters the “consume” during the node method execution, the node containing the consumed state will not set the dirty flag of its dependent nodes during the triggering process. In that case, all dependent nodes of the consumed node is not triggered even if the node is dirty. The arcs from the consumed node to the its dependent node becomes consumed arcs. However if a dirty bit is set by changing a node value, all dependent nodes of the dirty node are triggered. The triggering changes the state of all the dependent nodes to dirty. This will ensure all the dependent node methods are executed when those nodes are being traversed within the same computation cycle. The order of the dependent node traversal follows the orders of the node declarations in the CGD code. Another keyword “trigger” is used to control the triggering path. When a trigger is used alone in a node method, the node of the method ignores any previous consume statement. If the keyword, “trigger”, is followed by a node other than the node of the current method, that particular node state is set to dirty.

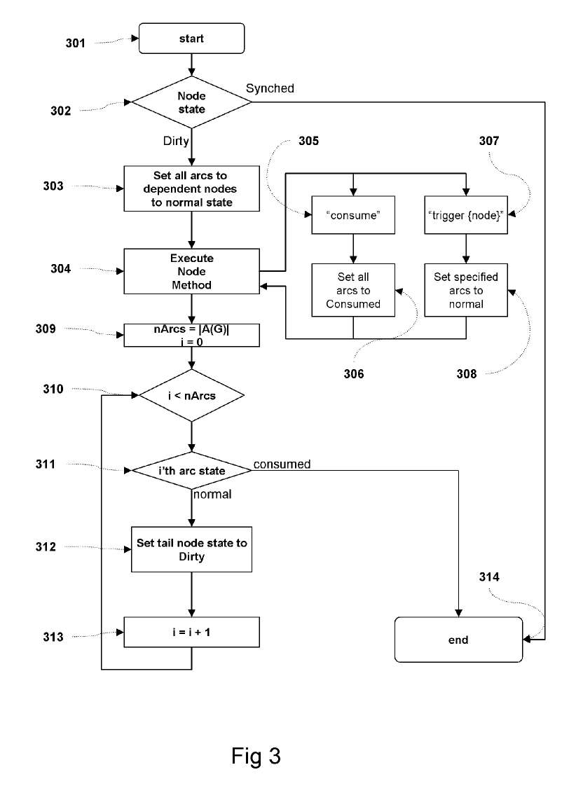

The present invention provides method of triggering a node whose detailed flow chart is depicted in FIG. 3. CGRM traverses each node instance from lowest to highest order. For each traversal of a node, CGRM performs a process of triggering that node. ³⁰²The process of triggering a node of a instance of graph (“node instance”) starts by checking its state. ³⁰³If a node instance is dirty, all arcs to dependent nodes becomes normal state meaning that the dependent nodes connected by normal arcs will be triggered during the traversal by CGRM. ³⁰⁴Then the node method is executed. During the execution of the node method, special triggering control statement “consume” or “trigger” may be executed. ³⁰⁵The execution of “consume” statement changes the state of all outgoing arcs of the current node to consumed state. ³⁰⁷The execution of “trigger” nullifies the consumed states by changing the specified arcs to become normal state. The optional node name list after the trigger specifies which arcs to be restores to normal state. If there is no node name, all outgoing arcs will become normal state. Once the execution of the node method is finished scheduling for subsequent triggering is followed. For each normal outgoing arcs, the dependent node of the arc becomes dirty. This will trigger the computation of the dependent node the same way stated above. If a node is not dirty at the beginning of this process, no actions will be taken and the process ends without any changes in the current node and the dependent nodes.

The present invention provides method of optimizing the path triggering by processing the path predetermined order which is given by CGD code. Following the predetermined order is equivalent of visiting all the nodes in the graph of the triggering subset. Nodes are arranged in the CGD that lower order node must appear before the higher order. The ordered graph is computed in its entirety by a computation cycle (“cycle”) from the low ordered node to highest ordered node to preserve relational integrity among the node values and to make computation efficient. In its computation cycle, no more than one computation will be done for each node according to its order regardless of number of concurrent events on the graph. The method of assigning node orders and rule to constraint the triggering node list in the CGD guarantees the traversing of the nodes that are affected by the events on the graph instance is minimal and the graph to be coherent after the computation cycle.

The process of computing cycle is managed by CGRM. When one or more events associated to a graph instance occurs, the graph instance will enter CGRM computation cycle queue (“cycle queue”) to be processed by the thread managed by CGRM. In the present invention, each graph instance has an in-queue flag holding true value if the graph is in the cycle queue, if not in queue the flag holds false value. The in-queue flag is set to true when an instance of a graph is waiting for computation cycle. While the instance is waiting in queue another event may happen to the graph instance. In that case, the graph will not enter into the cycle queue again because it is already in the queue indicated by in-queue flag. When an instance of graph becomes the head of the queue, the CGRM assigns a thread for the computation cycle, removes the instance of the graph from the queue, and sets the in-queue to false. The thread assigned by the CGRM traverse each node of the graph instance according to its node order and completes one computation cycle. Any new event occurred after the starting of computation cycle will make the graph instance to enter to cycle queue again, thus guaranteeing all the new events to be handled at the next round of computation cycle. For the new events while the graph is in computation cycle, the events will not be dispatched to changed the value of the nodes until the computation cycle is finished.

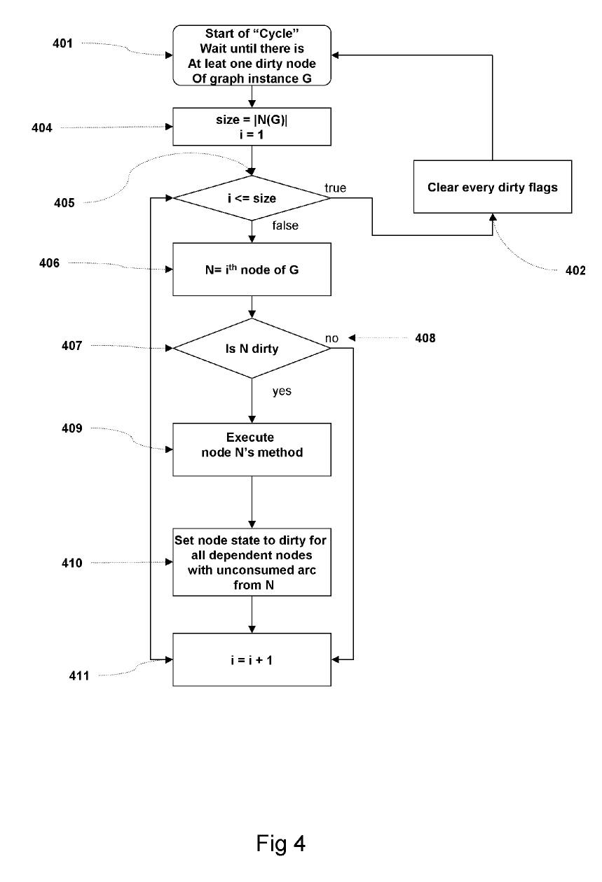

FIG. 4 illustrates the computation cycle performed for an instance of a computation graph (“G”) in the present invention. The process of graph synchronization is performed by visiting all nodes that are reachable from the dirty nodes. Once the synchronization of the graph is completed, the node in the graph instance is coherent with events. ⁴⁰¹When there is one or more node marked as dirty, the cycle starts. Once the cycle starts, all dirty flag changes caused by events associated with any node in the instance of the graph will be delayed until there are no more nodes to be visited. If two or more updates of the same node occur during the computation cycle, only the most recent is kept and the others are discarded. ⁴⁰²When the computation cycle finishes and all nodes flags become synched. ⁴⁰³Then those delayed dirty bit changes will be made if exist. The delayed dirty flags may be stored in temporary memory place during the computation cycle, and its implementation is obvious to those skilled in the art. The cycle goes into a loop where each node will be visited by its predetermined order. ⁴⁰⁴A variable “size” is assigned with the number of node of G(|N(G)|. ⁴⁰⁵After a temporary variable “I” is initialized to 1, the loop starts and continues until “i” is greater than the “size”. ⁴⁰⁶In the beginning of the loop, a reference to the I'th node of G is set to “N”. ⁴⁰⁷Then N is check to see if it is dirty. ⁴⁰⁸If N is not dirty, “i” will be incremented by one and goes to the beginning of the loop. ⁴⁰⁹However if N is dirty, N's method will be executed. ⁴¹⁰After N's method is executed, all dependent nodes of N with normal arc from N becomes dirty (process 410). ⁴¹¹Then the “i” is incremented by one and goes to beginning of the loop. After all nodes in G is tried for the conditional execution, All G's node becomes synched state. During the computation loop, any attempt to set dirty flag by changing node variable of G is delayed except when a node variable is changed and the changed node order is greater than the node order of N in the loop.

Referring FIG. 5, a computation graph “G” is illustrated with circles representing node and arrows representing arcs. The graph G has 7 nodes from N1 to N7 with distinctive node method from M1 to M7 as described in the CGD for the G. The graph G is a class of the instances that are to be created according to the graph class's dependent relationships and node methods. The graph G in FIG. 5 can be described in CGD which is also presented in the same figure, and be parsed by the CGD parser of this invention. Each node in graph G has corresponding node method which may be empty and omitted during the process of writing to CGD code. The N1's node method will be called M1, and N2's to M2 and so on for each node. Event sources can be attached to the instance of a graph which is created by a “new” operator with the graph name and optional constructor parameters in the CGD. The relationship between a graph and instance of a graph works much like the class and object instance relationship in C++ or Java. Therefore the method of the node is described and constructed into a data structure representing executable instructions for computer system in class of graph level. The node method is executed, meaning that the method data structure is executed by computer, during the computation cycle of a graph instance when one or more event occurs.

During the computation cycle of graph G, the topology of the graph instance will be dynamically changing by the triggering path control statement (“consume” and “trigger”) embedded in native CGD language or third party language grammar like those of C++ or Java. During a particular computation cycle of an instance of graph G, the node instance has exactly same topology of the graph G at time T1, which is right before the execution of the “consume” statement in the M4. At time T2 for the instance of the graph G, has no triggering path from N4 to N5, N6, N7 because consume statement prevent no further triggering under any condition. As depicted in FIG. 5, N4 becomes leaf node and N7 becomes orphan node in triggering relationship. However, At time T2, the “trigger this.N7” statement restores the original triggering relationship of the instance of the graph G at time T1. In the final topology of the instance of the graph G at time T3, N4 becomes intermediate node again and N7 becomes leaf node. After a completion of the single computation cycle the original triggering relationship will be restored for the next cycle. This method in the present invention will allow an instance of graph to change its topology after the graph has been instantiated.

In the present invention, traversing paths by multiple concurrent event is optimized by method of processing events in computation cycle. A graph triggering is managed by different thread, process, or across the network. The values in each node are protected from simultaneous access using proper synchronization method such as mutex, semaphore, and other computer system's synchronization objects. A general method of maintaining data coherency by simple node traversing for individual paths of the graph is not efficient in most cases. For example, let's assume two concurrent events associated with node N2 and N3 has occurred. Those events require traversal of four independent paths requiring multiple executions of some node methods to make the G data coherent where the four paths in the G are P(N2, N5,N6), P(N3,N4,N5,N6), P(N3, N4, N6), and P(N3, N4, N7). However, with the method of computation cycle, only a single visit of the each dirty node is needed to make the G data coherent. This results a minimal computation of node methods for all dirty nodes. The concurrent events associated with node N2 and N3 will result sequential execution of methods of M2, M3, M4, M5, M6, M7 in the computation cycle.

FIG. 6 explains the handling of events in a in the present invention by implementing a simple stock trading logic. The trading logic is to sell ABC stock when its bid price is higher than the fair value, and buy when its ask price is lower than the fair value to create profit while keeping track the number of shares in holding. No transaction costs are computed. The CGD code contains single graph definition including input nodes. The Bid, Ask, BSize, ASize nodes are representing bid, ask, bid size, and ask size information fed from the exchange where the stock is listed. The fair value node is linked to other event source which can be entered manually or automatically from the result of other graph.

A CGD code is written for a graph model, “SimpleModel”. The SimpleModel has a graph definition and a static function called main. The graph SimpleMode is a graph class where the nodes are defined. The CGRM in the present invention start execution of the code by running the main function first. The main function creates an instance of SimpleModel by new operator and assign the graph object to abcStock. When the abcStock is created, a constructor is being called and INITIMPLE function is executed. In the INITIMPLE one can write a program segment by calling appropriate libraries to bind node to event sources. In this example, Bid, Ask, BSize, ASize, and FV are bound to appropriate event source. When a node is bound to event source, the node value will change to reflect the current data from the event source and the dirty flag of the node will be set accordingly. When there is a change in bid price, ask price, bid size, ask size, it will trigger the computation of graph by entering a computation cycle, and the input node becomes dirty.

The SellQuat in FIG. 6 is fired when one of Bid, BSize, and FV is dirty. When SellQuant is fired, associated node method SELLSLOGIC is executed. The SELLSLOGIC in the CGD code is read by the parser and it is converted into a machine executable data structure. The parsed data structure then becomes SELLSLOGIC_X. The SELLSLOGIC_X can also be traversed according to the semantics of the SELLSLOGIC by the Computation Graph Runtime Module or translated to stream of machine instructions to storage device so that it can be loaded by Computation Graph Program Loader. The same parsing and translation process will be done to setup data structure for the BUYSLOGIC for the BuyQuant node, BOUGHTLOGIC for Bought node, SOLDLOGIC for Sold node, and POSCALC_X for Pos node.

The SELLSLOGIC first determines if the bid price is reasonably lower than the fair value in the node FV. In such case, the SELLSLOGIC determines number of shares to sell and assign the number to SellQuant. Since the SellQuant is updated, Sold node will be fired, the SOLDLOGIC_X is executed to compute number of shares that it can sell by referring the Cash node for available cash. After the number of shared that can be purchased for ABC stock is computed, the Sold node is updated, and the cash in the Cash node is adjusted for the exact amount necessary to purchase the ABC stock. The cash value update is done within the SOLDLOGIC which has an assignment statement to update the node Cash. In the present invention, the forward update like this also sets the dirty state as well, so that even if the forward node is not linked by the path, the forward node will be fired when the Computation Graph Runtime Module reaches the node during the graph computation cycle according to its order in the CGD code. This dirty bit set by forward update is implemented in the assignment statement in the node method. The updated Sold node then triggers the Pos node which adjusts the current position information of the stock ABC. The position information is computed by the POSCALC.

The buy side path from (ASK, ASize, FV) to {BuyQuant}, to {Sold}, to {Pos and Cash} works similarly to the sell side path. This path can occur concurrently with sell side which can logically create competing situation if the bid and ask spread is unusually high. In such a case BuySell flag node will determine the competitiveness of buy and sell path by checking an appropriate logic. The BuySell node can be used by both Bought and Sold node to decide which mutually exclusive actions to take. The concurrency in the present invention is handled by the Computation Graph Runtime module.

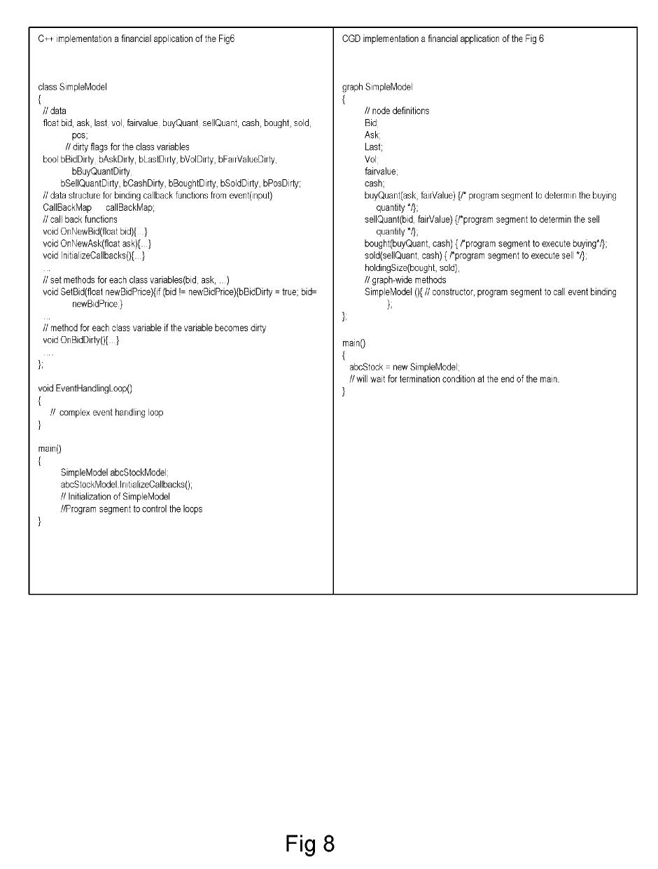

In FIG. 8, a rough comparison between conventional programming language and CGD implementation of a sample financial application described above has been made to show the readability of CGD code in describing a real-time event driven processes. In the C++ example, the dependency relationships among variables are not visible at the class level and can only be understood by following the steps of executions in the implementations of methods. On the other hand, the CGD code shows clearly the dependent relationships at the object level without referring to any method. The CGD code also shows the actions to be taken when the triggering nodes values are changed. The benefits of using CGD code in describing dependent relationship among variables are much more obvious with larger set of dependent relationships.

It will be apparent to persons skilled in the computer software arts that numerous variations and modifications may be made to the event driven computations using the coherency of the computation graph in addition to those already described, without departing from the basic inventive concepts. For example, the methods and computer storages can be broken into different modules, or some of the incomplete grammar rules can be implemented with variations of exiting computer programming languages. All such variations and modifications are to be considered within the scope of the present invention, the nature of which is to be determined from the foregoing description and the appended claims.

What is claimed is:

1. A method of processing concurrent events in computation graph system comprising:
Storing a class of computation graph description to computer storage as CGD code
Receiving CGD code defining a class of computation graph;
Elaborating a plurality of instances of the computation graph according to the received CGD code;
Processing events bound to an instance of computation graph.

2. The method as recited in claim 1, wherein storing a computation graphs description to computer storage as CGD code compliant with CGD grammar is carried out using a computer program which is capable of storing textual information to computer storage.

3. The method as recited in claim 2, wherein storing computation graph nodes and its dependency relationship to computer storage as CGD code compliant with CGD grammar is carried out using a computer program which is capable of storing textual information to computer storage, the method comprising the steps of;
Select a node in the computation graph to be described;
Repeatedly:
Storing the selected node's type;
Storing the select node name;
Storing a symbol indicating the beginning of the triggering node list of the selected node;
Repeatedly:
Storing a name of triggering node chosen from the previously stored nodes of the computation graph of the selected node;
Until all triggering nodes of the selected node are stored;
Storing a symbol indicating the end of the triggering node list of the selected node;
Storing the selected node's method; and
Select a node from the graph that hasn't been stored;
Until all nodes in the computation graph has been stored.

4. The method as recited in claim 1, wherein the receiving CGD code is carried out by parsing the code comprising the steps of:
The CGD parser reads the CGD code from computer storage to assure the code is compliant with the CGD grammar;
The CGD parser applies CGD grammar to the CGD code for generating data structure corresponding to the computation graph classes described by the CGD code;
The CGD parser applies CGD grammar to the CGD code for generating data structure containing machine executable instructions corresponding to the node methods described by the CGD code;
The CGD parser stores the data structure and the machine executable instructions to computer storage.

5. The method as recited in claim 4, wherein the order of node in the data structure corresponding to the computation graph class is assigned according to the order of node's lexical appearance in the CGD code.

6. The method as recited in claim 4, wherein a computation graph description in the CGD code is rejected by the parser if a triggering node in triggering node list is not declared prior to the node containing the triggering node list.

7. The method as recited in claim 4, wherein other language grammar based computer executable codes can be embedded in the node method.

8. The method as recited in claim 4, wherein any node of the computation graph can be accessed using an access operator from node method.

9. The method as recited in claim 1, wherein the elaborating further comprises elaborating the data structure into instances of computation graph.

10. The method as recited in claim 1, the method of processing of multiple concurrent events is performed by applying computation cycle on an instance of computation graph, wherein the instance of computation graph has a plurality of ordered nodes.

11. The method of processing a set of multiple concurrent events bound to a computation graph instance by applying computation cycle on an instance of computation graph.

12. The method as recited in claim 11, the method of computation cycle is repeatedly applied on an instance of computation graph for external events dispatched to the instance of computation graph, the method comprising the steps of:
Wait for events;
select the first node from the graph according to node order;
Repeatedly:
if the selected node is dirty then:
execute selected node method;
for every dependent node of the selected node:
change the state of the dependent node to dirty if the connecting arc's state is normal;
make the selected node synched;
otherwise do nothing; and
select a node with next order from the graph;
Until all nodes in the graph has been selected.

13. The method as recited in claim 11, wherein the computation graph instance graph is created according to data structure created by CGD parser.

14. The method as recited in claim 11, a normal arc in a computation graph becomes consumed state when a “consume” instruction is executed in a node method.

15. The method as recited in claim 11, consumed arcs of a node in a computation graph is restored to normal state when a “trigger” instruction is executed in the node method.

16. A computer readable computer storage having computer executable instructions and data structure thereon processing multiple concurrent events using computation graph described by CGD code comprising:
Receiving CGD code defining a class of computation graph;
Elaborating a plurality of instances of the computation graph according to the received CGD code;
Processing events bound to an instance of computation graph.

17. A computer readable computer storage as recited in claim 16, having computer executable parser thereon parsing a CGD code compliant with CGD grammar, parsing the code comprising the steps of:
The CGD parser reads the CGD code from computer storage to assure the code is compliant with the CGD grammar;
The CGD parser applies CGD grammar to the CGD code for generating data structure corresponding to the computation graph classes described by the CGD code;
The CGD parser applies CGD grammar to the CGD code for generating data structure containing machine executable instructions corresponding to the node methods described by the CGD code;
The CGD parser stores the data structure and the machine executable instructions to computer storage.

18. A computer readable computer storage as recited in claim 16, the instruction and data structure being organized into modules comprising:
A module for data structure representing computation graph class;
A module for data structure to hold computer executable node methods repeatedly executed by applying computation cycle;
A module containing instructions for computation graph runtime which processes concurrent event by repeatedly applying the method of computation cycle on an instance of computation graph.

19. A computer readable computer storage as recited in claim 16, having computer executable instructions thereon processing multiple concurrent events by applying computation cycle on an instance of computation graph, wherein the instance of computation graph has a plurality of ordered nodes.
